(19) United States
(12) Patent Application Publication
(10) Pub. No.: US 2026/0001528 A1
(43) Pub. Date: Jan. 1, 2026

(54) PARKING ASSISTANCE SYSTEM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Tomohisa YAMASHITA, Tokyo (JP); Ichiya SHIMOMURA, Nagoya-shii (JP); Keisuke OYAMA, Nisshin-shi (JP); Yuki MINASE, Toyota-shi (JP); Motonari OBAYASHI, Nagakute-shi (JP)

(21) Appl. No.: 19/322,107

(22) Filed: Sep. 8, 2025

Related U.S. Application Data
(63) Continuation of application No. PCT/JP2024/006951, filed on Feb. 27, 2024.

(30) Foreign Application Priority Data
Mar. 10, 2023 (JP) 2023-037291

(51) Int. Cl. B60W 30/06; B60W 10/20; B60W 30/14; B60W 50/14; G06V 20/58; G08G 1/14

(52) U.S. Cl. CPC B60W 30/06; B60W 10/20; B60W 30/143; B60W 50/14; G06V 20/586; G08G 1/143; B60W 2050/143; B60W 2050/146; B60W 2420/403; B60W 2520/10

(57) ABSTRACT

A parking assistance system for a vehicle is provided. The parking assistance system includes a travel state determination unit, an environment recognition unit, an assistance level determination unit, and a parking control unit. The travel state determination unit determines a travel state of the vehicle: The environment recognition unit recognizes a surrounding environment of the vehicle. The assistance level determination unit determines an assistance level for parking the vehicle based on the travel state and the environment. The parking control unit performs parking control based on the determined assistance level.

### CROSS-REFERENCE TO RELATED APPLICATIONS

The present application is a continuation application of International Application No. PCT/JP2024/006951, filed on Feb. 27, 2024, which claims priority to Japanese Patent Application No. 2023-037291, filed on Mar. 10, 2023. The contents of these applications are incorporated herein by reference in their entirety.

### BACKGROUND

### Technical Field

The present disclosure relates to a parking assistance system.

### Background Art

Various types of technology for assisting in parking of a vehicle have been proposed. For example, a technology is known in which whether a vehicle is present on private land or a public road is determined, and parking is performed by driverless parking only when the vehicle is determined to be on private land.

### SUMMARY

An aspect of the present disclosure provides a parking assistance system for a vehicle. The parking assistance system recognizes a surrounding environment of the vehicle, determines an assistance level for parking the vehicle based on the travel state and the environment, and performs parking control based on the determined assistance level.

### BRIEF DESCRIPTION OF THE DRAWINGS

In the accompanying drawings:

FIG. 1 is a block diagram illustrating an overall configuration of a parking assistance system according to an embodiment of the present disclosure;

FIG. 2 is a flowchart illustrating steps in a parking assistance process according to a first embodiment;

FIG. 3 is an explanatory diagram schematically illustrating an example of parking assistance according to the first embodiment;

FIG. 4 is an explanatory diagram schematically illustrating an example of parking assistance according to the first embodiment;

FIG. 5 is a block diagram illustrating an overall configuration of a parking assistance system according to a second embodiment;

FIG. 6 is an explanatory diagram schematically illustrating an example of parking assistance according to the second embodiment;

FIG. 7 is a block diagram illustrating an overall configuration of a parking assistance system according to a third embodiment; and

FIG. 8 is an explanatory diagram schematically illustrating an example of parking assistance according to the third embodiment.

### DESCRIPTION OF THE EMBODIMENTS

Various types of technology for assisting in parking of a vehicle have been proposed. For example, JP 2021-501943 A discloses a technology in which whether a vehicle is present on private land or a public road is determined, and parking is performed by driverless parking only when the vehicle is determined to be on private land.

However, the technology in JP 2021-501943 A is a technology for assisting in parking only on private land. Therefore, a configuration to perform both driving assistance in a preparation stage for parking while the vehicle is traveling on other than private land, such as a public road, and parking assistance at a parking site has not been examined at all. Thus, there is room for improvement regarding parking assistance for a vehicle.

The present disclosure can be implemented according to the following aspect.

An exemplary embodiment of the present disclosure provides a parking assistance system for a vehicle. The parking assistance system includes a travel state determination unit, an environment recognition unit, an assistance level determination unit, and a parking control unit. The travel state determination unit determines a travel state of the vehicle: The environment recognition unit recognizes a surrounding environment of the vehicle. The assistance level determination unit determines an assistance level for parking the vehicle based on the travel state and the environment. The parking control unit performs parking control based on the determined assistance level.

As a result of the parking assistance system according to the exemplary embodiment, because the assistance level determination unit that determines the assistance level for parking the vehicle based on the travel state and the environment, and the parking control unit that performs parking control based on the determined assistance level are provided, appropriate parking assistance can be performed based on the travel state and the environment.

The above-described object, other objects, characteristics, and advantages of the present disclosure will be further clarified through the detailed description herebelow, with reference to the accompanying drawings.

### A. First Embodiment

A1. Configuration of a parking assistance system 100

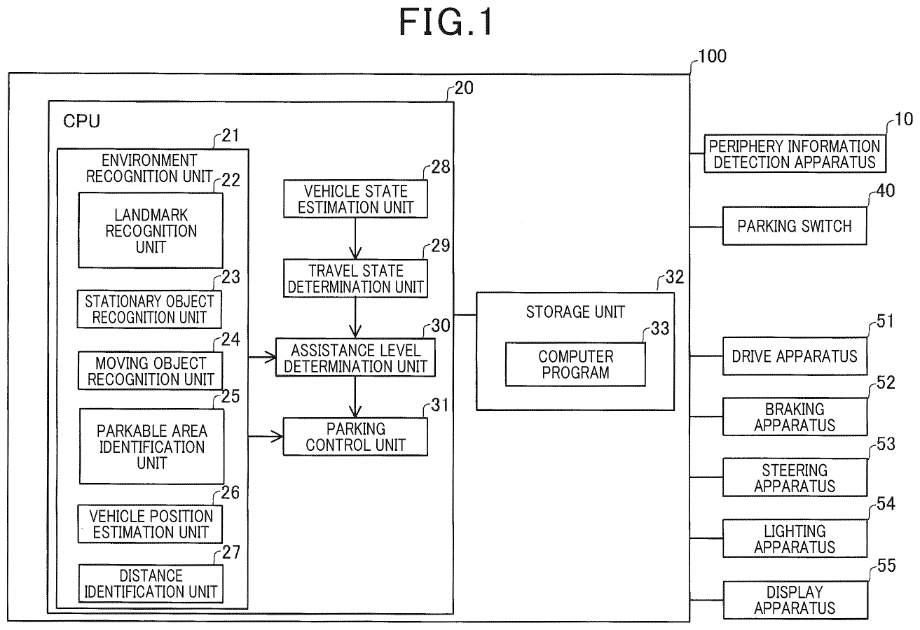

A parking assistance system 100 shown in FIG. 1 is mounted in a vehicle and assists in parking based on a travel state of the vehicle and a surrounding environment of the vehicle. Here, the vehicle in which the parking assistance system 100 is mounted is also referred to, hereafter, as an “own vehicle.” The own vehicle includes, in addition to the parking assistance system 100, a periphery information detection apparatus 10, a drive apparatus 51, a braking apparatus 52, a steering apparatus 53, a display apparatus 55, and a parking switch 40.

The periphery information detection apparatus 10 is an apparatus that detects an object present in a vicinity of the own vehicle. For example, the periphery information detection apparatus 10 may include a camera that captures images of an area ahead of and surrounding the own vehicle, a millimeter radar, an ultrasonic sonar, and Light Detection And Ranging (LiDAR). For example, objects detected by the periphery information detection apparatus 10 may include people, animals, vehicles other than the own vehicle, bicycles, buildings, walls, columns, road signs, and traffic lanes. The periphery information detection apparatus 10 is electrically connected to the parking assistance system 100 and transmits the detected information to the parking assistance system 100.

The drive apparatus 51 outputs drive force for making the own vehicle travel. For example, the drive apparatus 51 may be an internal combustion engine or a motor. The drive apparatus 51 is electrically connected to the parking assistance system 100, and the drive force is controlled by control signals transmitted from the parking assistance system 100.

The braking apparatus 52 outputs braking force for braking the own vehicle. For example, the braking apparatus 52 may be a brake apparatus. The braking apparatus 52 is electrically connected to the parking assistance system 100, and the braking force is controlled by control signals transmitted from the parking assistance system 100.

The steering apparatus 53 outputs steering force for steering the own vehicle. For example, the steering apparatus 53 may be a power steering apparatus. The steering apparatus 53 is electrically connected to the parking assistance system 100, and steering is controlled by control signals transmitted from the parking assistance system 100.

A lighting apparatus 54 is an illumination apparatus that illuminates the vicinity of the own vehicle and a turn signal. The illumination apparatus includes headlights, taillights, and position lights. The headlights are attached to a front surface of the own vehicle and illuminate the area ahead of the own vehicle. The taillights are attached to a rear portion of the own vehicle and function as illumination for a marker enabling another vehicle behind the own vehicle to visually recognize the own vehicle. The position lights are attached in the vicinity of the headlights and function as illumination notifying the surrounding of the presence of the vehicle. The turn signals are disposed in pairs on the left and right at the front and rear of the own vehicle, and function to notify the surrounding of a turn direction of the own vehicle. In addition, as a result of all turn signals being flashed, the turn signals function as hazard lights and function to alert people and vehicles in the vicinity. The lighting apparatus 54 is electrically connected to the parking assistance system 100, and switching between on and off is controlled by control signals transmitted from the parking assistance system 100.

The display apparatus 55 is mounted inside a vehicle cabin of the own vehicle and provides visual information to a passenger of the own vehicle. For example, the display apparatus 55 may be a touch-panel-type display. The display apparatus 55 is electrically connected to the parking assistance system 100 and displays various types of visual information by control signals transmitted from the parking assistance system 100.

The parking switch 40 is a switch for starting parking assistance by the parking assistance system 100, described hereafter. For example, the parking switch 40 may be a button provided inside the own vehicle. As a result of the passenger pressing the button, parking assistance is started. Here, the parking switch 40 may be provided as a touch panel in the display apparatus 55 inside the own vehicle.

The parking assistance system 100 is configured by a central processing unit (CPU) 20 and a storage unit 32. More specifically, the parking assistance system 100 is configured as an electronic control unit (ECU). For example, the storage unit 32 may be a read-only memory (ROM), a random access memory (RAM), or a hard disk drive (HDD). The storage unit 32 stores various types of information and a computer program 33 to enable the parking assistance system 100 to function.

The CPU 20 functions as an environment recognition unit 21, a vehicle state estimation unit 28, a travel state determination unit 29, an assistance level determination unit 30, and a parking control unit 31 by executing the computer program 33 stored in the storage unit 32.

The environment recognition unit 21 recognizes a surrounding environment of the own vehicle using the periphery information detected by the periphery information detection apparatus 10. The environment recognition unit 21 includes a landmark recognition unit 22, a stationary object recognition unit 23, a moving object recognition unit 24, a parkable area identification unit 25, a vehicle position estimation unit 26, and a distance identification unit 27.

The landmark recognition unit 22 recognizes solid objects that do not move and road surface patterns. For example, the solid objects that do not move may include buildings, ditches, gates, walls, utility poles, streetlights, and road signs. For example, the road surface patterns may include road surface paint, traffic lanes, tiles, and grass.

The stationary object recognition unit 23 recognizes stationary objects. For example, the stationary objects may be people, animals, vehicles other than the own vehicle, and bicycles that are in a stationary state. The stationary object recognition unit 23 differs from the landmark recognition unit 22 in that the stationary object recognition unit 23 recognizes a stationary object that may move.

The moving object recognition unit 24 recognizes moving objects. For example, the moving objects may be people, animals, vehicles other than the own vehicle, and bicycles in a moving state.

The parkable area identification unit 25 identifies a location where the own vehicle is able to park. For example, the parkable area may include a parking area demarcated by white lines inside a parking site, an empty lot that has space where the own vehicle is able to park, and a parking area registered in advance such as a garage at home. Here, the parking area registered in advance can be stored in the storage unit 32. Identification of the parkable area may be performed using map information stored in the storage unit 32.

The vehicle position estimation unit 26 estimates a position of the own vehicle. For example, the vehicle position estimation unit 26 may be configured as a Global Positioning System (GPS). For example, the vehicle position estimation unit 26 may estimate the position of the own vehicle on a map using the map information stored in the storage unit 32. Here, the vehicle position estimation unit 26 is not limited to the GPS and may be configured as a Global Navigation Satellite System (GNSS) of an arbitrary type.

The distance identification unit 27 identifies a distance between a target and the own vehicle, the target being that recognized by the landmark recognition unit 22, the stationary object recognition unit 23, the moving object recognition unit 24, and the parkable area identification unit 25. Here, the “distance between the target and the own vehicle” refers to a distance (that is, a travel distance) when the own vehicle follows a route on which the own vehicle is able to travel. More specifically, the “distance between the target and the own vehicle” refers to a distance on a route along a traffic lane recognized by the landmark recognition unit 22 or a route for moving such as to avoid targets recognized by the stationary object recognition unit 23 and the moving object recognition unit 24. Identification of the distance by the distance identification unit 27 may be performed using the position of the own vehicle estimated by the vehicle position estimation unit 26 and the map information stored in the storage unit 32.

The vehicle state estimation unit 28 estimates a state of the own vehicle. Specifically, the vehicle state estimation unit 28 estimates an acceleration, a speed, an amount of movement, a steering angle, an own vehicle position, a road surface gradient of a road being traveled, and the like of the own vehicle using the periphery information detected by the periphery information detection apparatus 10 and output states of the drive apparatus 51, the braking apparatus 52, and the steering apparatus 53. Here, the vehicle state estimation unit 28 may perform estimation of the state of the own vehicle using environment information recognized by the environment recognition unit 21. The estimated vehicle state is transmitted to the travel state determination unit 29.

The travel state determination unit 29 determines the travel state of the own vehicle using the state of the vehicle estimated by the vehicle state estimation unit 28. The travel state includes a stopped state, a low-speed (such as 30 km per hour or lower) traveling state, a medium-speed (such as 30 to 60 km per hour) traveling state, a high-speed (such as 60 km per hour or higher) traveling state, and the like. The determined travel state is transmitted to the assistance level determination unit 30.

The assistance level determination unit 30 determines an assistance level for parking assistance using the surrounding environment of the own vehicle recognized by the environment recognition unit 21 and the travel state determined by the travel state determination unit 29. The assistance level for parking assistance according to the present embodiment is composed of three assistance levels, that is, a first assistance level, a second assistance level, and a third assistance level. A method for determining the assistance level will be described hereafter. The determined assistance level is transmitted to the parking control unit 31.

The parking control unit 31 performs parking control based on the assistance level determined by the assistance level determination unit 30. For example, parking control may include notification to the passenger of a route to a parkable area, vehicle speed control, and steering control. The parking control unit 31 implements parking control of the own vehicle by transmitting control signals to the drive apparatus 51, the braking apparatus 52, the steering apparatus 53, and the display apparatus 55. Details of parking control of the own vehicle will be described hereafter.

### A2. Parking Assistance Process

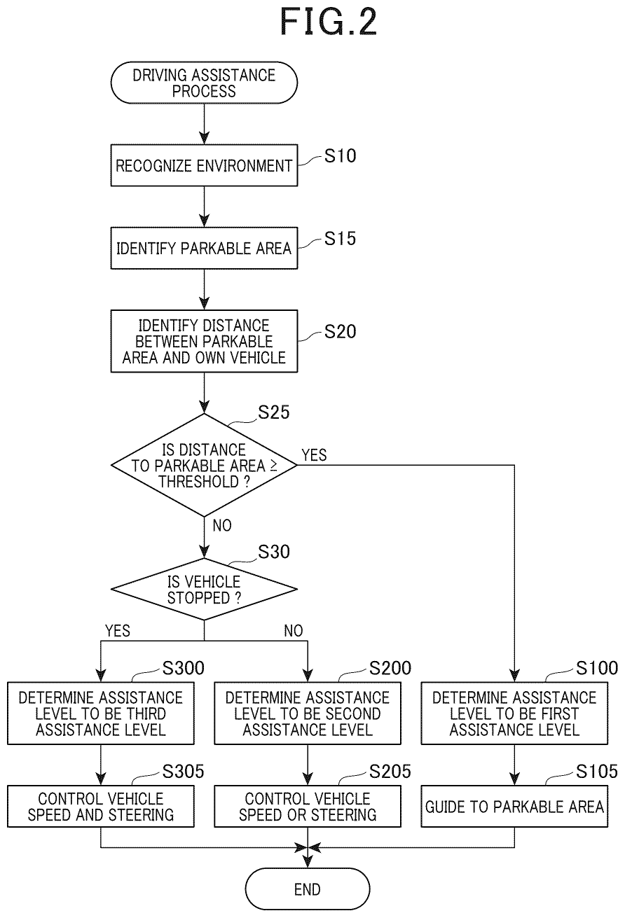

A parking assistance process shown in FIG. 2 is a process for assisting in parking the own vehicle and is performed by the parking switch 40 being pressed. The environment recognition unit 21 recognizes the surrounding environment of the own vehicle (step S10). More specifically, in each of the landmark recognition unit 22, the stationary object recognition unit 23, the moving object recognition unit 24, and the parkable area identification unit 25 provided in the environment recognition unit 21, a functional unit recognizes a recognizable target. In addition, the vehicle position estimation unit 26 estimates the position of the own vehicle on a map.

The parkable area identification unit 25 identifies the parkable area (step S15). The distance identification unit 27 identifies the distance between the identified parkable area and the own vehicle (step S20). The assistance level determination unit 30 performs a comparison of the distance identified by the distance identification unit 27 and a threshold prescribed in advance. More specifically, the assistance level determination unit 30 determines whether the distance identified by the distance identification unit 27 is equal to or greater than the threshold prescribed in advance (step S25). The threshold prescribed in advance is stored in the storage unit 32 in advance. For example, the threshold prescribed in advance may be 50 m. When the distance identified by the distance identification unit 27 is equal to or greater than the threshold prescribed in advance (YES at step S25), that is, when the distance from the own vehicle to the parkable area is relatively far, the assistance level determination unit 30 determines the assistance level to be the first assistance level (step S100).

The parking control unit 31 provides the passenger of the own vehicle with guidance to the parkable area identified at step S15 (step S105). For example, guidance to the parkable area may be notification of a route to the parkable area or a position of the parkable area inside a parking site. The route to the parkable area and the position of the parkable area are identified using the environment recognized by the environment recognition unit 21. More specifically, the route to the parkable area and the position of the parkable area are identified using the position of the own vehicle estimated by the vehicle position estimation unit 26 and the map information stored in the storage unit 32. For example, the notification may be performed by the route to the parkable area or the position of the parkable area being displayed in the display apparatus 55. In addition, such notification may be performed by the passenger being informed of the route to the parkable area by audio.

When the distance identified by the distance identification unit 27 is less than the threshold prescribed in advance (NO at step S25), that is, when the distance to the parkable area from the own vehicle is relatively near, the assistance level determination unit 30 determines whether the own vehicle is stopped (step S30). The determination is made using the travel state of the own vehicle determined by the travel state determination unit 29. When the own vehicle is not stopped (NO at step S30), that is, when the own vehicle is traveling, the assistance level determination unit 30 determines that the assistance level is the second assistance level (step S200). The parking control unit 31 performs only either of vehicle speed control or steering control of the own vehicle (step S205). Vehicle speed control is implemented by the parking control unit 31 sending control signals to the drive apparatus 51 and the braking apparatus 52. For example, vehicle speed control may be performed inside the parking site. Inside the parking site, a pedestrian may dart out from an area that is a blind spot due to other vehicles. Therefore, the parking control unit 31 performs vehicle speed control such that the vehicle speed inside the parking site is equal to or less than 5 km. Here, steering control in this case, that is, operation of the steering apparatus 53 is manually performed by the passenger.

In addition, steering control is implemented by the parking control unit 31 sending control signals to the steering apparatus 53. For example, steering control may be performed in a relatively narrow parking site. On a route to the parkable area in the relatively narrow parking site, collision with another vehicle, a building, a wall, or the like may occur. Therefore, the parking control unit 31 suppresses collision by performing steering control and guides the own vehicle to the parkable area. In steering control, the environment recognition unit 21 recognizes the other vehicle and the like. Here, vehicle speed control in this case, that is, operation of the drive apparatus 51 and the braking apparatus 52, is manually performed by the passenger. That is, parking control at the second assistance level can also be said to be semi-autonomous driving.

When the vehicle is stopped (YES at step S30), that is, when the own vehicle is traveling, the assistance level determination unit 30 determines the assistance level to be the third assistance level (step S300). The parking control unit 31 performs vehicle speed control and steering control of the own vehicle (step S305). In this case, the own vehicle can be said to be in an autonomous driving state by the parking assistance system 100. As a result of autonomous driving by the parking control unit 31, parking in the parkable area is performed. The autonomous driving is performed by the parking control unit 31 sending control signals to the drive apparatus 51, the braking apparatus 52, the steering apparatus 53, and the lighting apparatus 54 using the information recognized by the environment recognition unit 21. Because transition is made to autonomous driving by the process at step S305 after the own vehicle is confirmed to be stopped in the process at step S30, compared to a configuration in which the own vehicle transitions to autonomous driving while traveling, safety can be further ensured.

The parking assistance process described above is repeatedly performed until the parking in the parkable area is completed or an instruction to end parking assistance is inputted by the passenger. That is, as a result of the passenger pressing the parking switch 40, continuous parking assistance from the first assistance level to the third assistance level can be performed.

### A3. Example of Parking at Own Home H by the Parking Assistance System 100

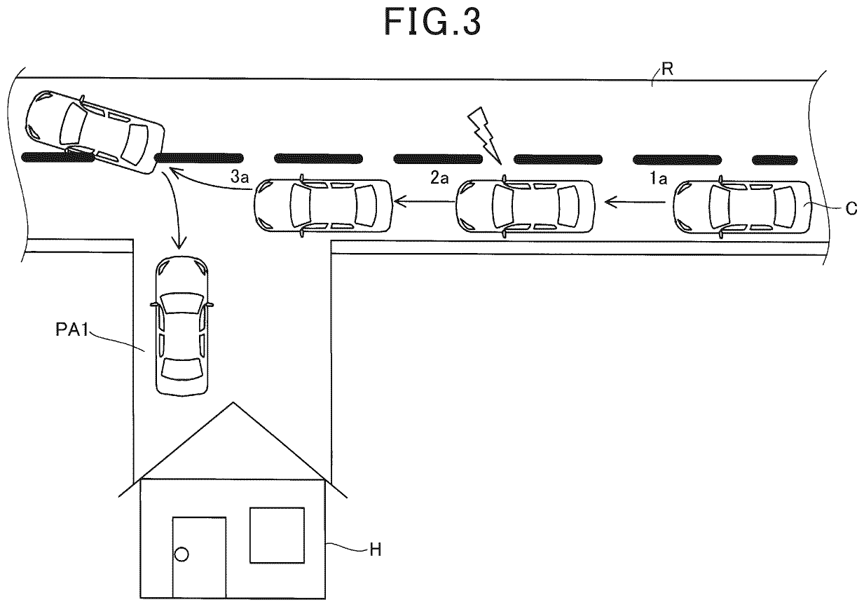

In an example of parking assistance shown in FIG. 3, parking assistance for an own vehicle C to park in a parkable area PA1 in front of an own home H is performed. Arrows in FIG. 3 show an advancing direction of the own vehicle C. The own vehicle C parks in the parkable area PA1 by parking assistance being performed in order from the first assistance level to the third assistance level. Here, the parkable area PA1 in the example shown in FIG. 3 is a location registered in advance in the storage unit 32.

In the own vehicle C traveling on a road R, when the parking switch 40 is pressed, parking assistance by the parking assistance system 100 is started. As a result of the environment recognition unit 21 recognizing the surrounding environment of the own vehicle C, because the distance of the own vehicle C at position 1a to the own home H is equal to or greater than a threshold prescribed in advance, the assistance level determination unit 30 determines the assistance level to be the first assistance level. The parking control unit 31 performs parking assistance at the first assistance level by displaying a route and the distance to the own home in the display apparatus 55 of the own vehicle C.

When the own vehicle C advances to position 2a closer to the parkable area PA1 than position 1a, the assistance level determination unit 30 determines that the distance to the parkable area PA1 is less than the threshold prescribed in advance. Furthermore, because the own vehicle C is not stopped, the assistance level determination unit 30 determines the assistance level to be the second assistance level. In the example shown in FIG. 3, as the parking assistance at the second assistance level, vehicle speed control by the parking control unit 31 is performed. The own vehicle C travels at 5 km per hour by vehicle speed control. Here, steering of the own vehicle C during this period is performed by the passenger. As a result of the vehicle speed being controlled to a low speed such as 5 km per hour in this manner, the passenger can be notified that the parkable area PA1 is close by and the passenger can be alerted to be careful of pedestrians suddenly darting out from the parkable area PA1. In addition, as a result of the vehicle speed being controlled to a low speed, a smooth transition to a stopped state that is a condition for the subsequent parking assistance at the third assistance level can be made.

When the own vehicle C is stopped at position 3a, the assistance level determination unit 30 determines the assistance level to be the third assistance level. The parking control unit 31 performs autonomous parking in the parkable area PA1 by performing vehicle speed control and steering control. As shown in FIG. 3, significantly running out into an opposite traffic lane may be required to perform parking. Because there is risk of an oncoming vehicle approaching from the opposite traffic lane at this time, safety can be ensured by the parking assistance at the third assistance level being performed after the vehicle is stopped. In addition, as a result of the passenger stopping the own vehicle C near the parkable area PA1, the assistance level can be switched from the second assistance level to the third assistance level, and the parking operation can be performed by fully autonomous driving. Here, stopping of the own vehicle C by the passenger can be said to be an indication of intent to transition to autonomous driving.

In this manner, as a result of parking assistance being continuously performed from the first assistance level to the third assistance level, parking in the parkable area PA1 in front of the own home H is performed.

### A4. Example of Parking in a Parking Site P by the Parking Assistance System 100

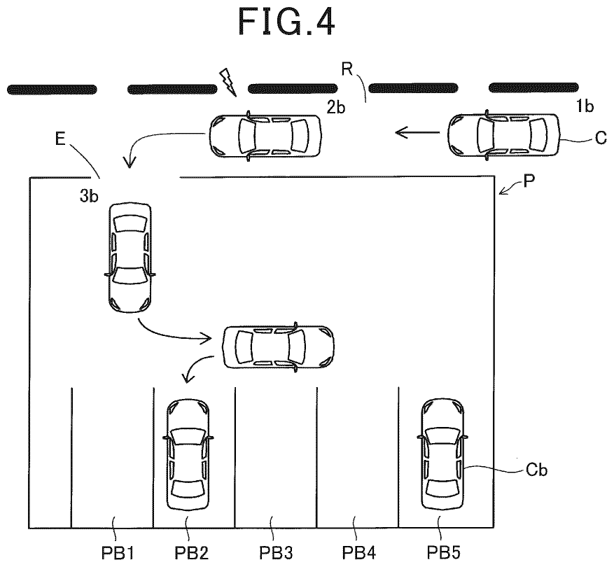

Parking in a parking site P shown in FIG. 4 differs from parking at the own home, described above, in that the parkable area is not a location registered in advance. The parking assistance system 100 finds a parkable area in the vicinity of the own vehicle C and performs parking assistance.

Specifically, when the passenger of the own vehicle C traveling on the road R presses the parking switch 40 at position 1b, the environment recognition unit 21 starts recognition of the surrounding environment of the own vehicle C. The parkable area identification unit 25 identifies the parking site P as the parkable area using the vehicle position estimated by the vehicle position estimation unit 26 and the map information stored in the storage unit 32. Here, identification may be performed by the landmark recognition unit 22 recognizing a sign indicating the parking site P or the like. The distance identification unit 27 identifies a distance between the parking site P and the own vehicle C. When the identified distance is equal to or greater than a distance prescribed in advance, the assistance level determination unit 30 determines the assistance level to be the first assistance level. The parking control unit 31 performs parking assistance at the first assistance level by displaying a route and a distance to an entrance of the parking site P in the display apparatus 55 of the own vehicle C.

When the own vehicle C advances to position 2b closer to the parkable area than position 1b, the assistance level determination unit 30 determines that the distance to the parking site P is less than the threshold prescribed in advance. Furthermore, because the own vehicle C is not stopped, the assistance level determination unit 30 determines the assistance level to be the second assistance level. The parking control unit 21 performs vehicle speed control of the own vehicle C and makes the own vehicle C travel at 5 km per hour. In addition, when an entrance E to the parking site P is relatively narrow as shown in FIG. 4, the parking control unit 31 may perform steering control to smoothly guide the own vehicle C into the parking site P while avoiding collision with walls.

When the own vehicle C stops at position 3b inside the parking site P, the assistance level determination unit 30 determines the assistance level to be the third assistance level. The parkable area identification unit 25 identifies, among five parking sections PB1, PB2, PB3, PB4, and PB5, the parking sections PB1, PB2, PB 3, and PB4 other than the parking section PB5 in which another vehicle Cb is parked as the parkable areas. The actual parkable area in which the own vehicle C is to be parked may be arbitrarily determined by the parkable area identification unit 25 or selected by the passenger. In the example shown in FIG. 4, the parking section PB2 is determined to be the parkable area by the parkable area identification unit 25. The parking control unit 31 performs autonomous parking in the parking section PB2 by performing vehicle speed control and steering control.

As a result of the parking assistance system 100 according to the first embodiment described above, because the assistance level determination unit 30 that determines the assistance level for parking a vehicle based on the travel state and the environment, and the parking control unit 31 that performs parking control based on the determined assistance level are provided, appropriate parking assistance based on the travel state and the environment can be performed.

In addition, the assistance level determination unit 30 determines the assistance level to be the first assistance level when the distance to the parkable area is equal to or greater than the distance prescribed in advance, and determines the assistance level to be the second assistance level or the third assistance level when the distance to the parkable area is less than the distance prescribed in advance. Therefore, parking assistance based on the distance to the parkable area can be performed.

Furthermore, the assistance level determination unit 30 determines the assistance level to be the second assistance level when the vehicle is traveling and determines the assistance level to be the third assistance level when the vehicle is stopped, under the condition that the distance to the parkable area is less than the threshold prescribed in advance. Therefore, parking assistance based on the travel state of the vehicle can be performed. In addition, the parking control unit 21 performs vehicle speed control and steering control as the third assistance level when the vehicle is in the stopped state. Therefore, compared to a configuration in which vehicle speed control and steering control are also performed when the vehicle is in the traveling state, the passenger can be given an opportunity to confirm safety when transitioning to autonomous driving and accidents during transition to autonomous driving can be suppressed.

Moreover, autonomous driving is performed when the assistance level is the third assistance level in which the distance to the parkable area is less than the threshold and the vehicle is in the stopped state. Therefore, compared to a configuration in which autonomous driving is performed even when the distance to the parkable area is far or the vehicle is in the traveling state, processing load on the system required for autonomous driving can be reduced. In addition, compared to a configuration in which autonomous driving is performed even when the vehicle is in the traveling state, manufacturing cost can be reduced because advanced sensors, calculation processing apparatuses, and the like are not required.

### B. Second Embodiment

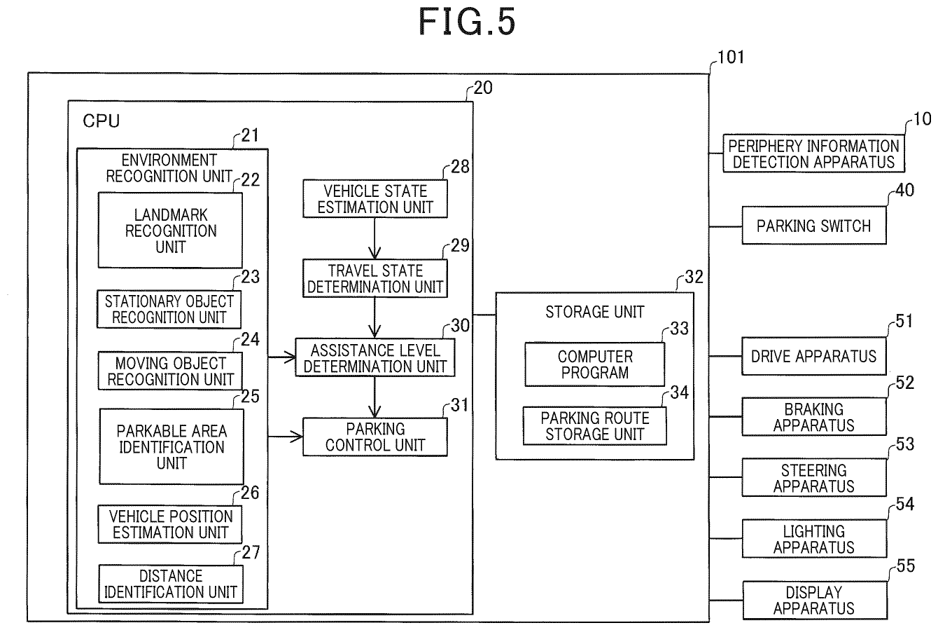

A parking assistance system according to a second embodiment shown in FIG. 5 differs from the parking assistance system 100 according to the first embodiment in that a parking route storage unit 34 is further provided. Other configurations of the parking assistance system 101 according to the second embodiment are identical to those of the parking assistance system 100 according to the first embodiment. Therefore, identical constituent elements are given the same reference numbers and detailed descriptions thereof are omitted.

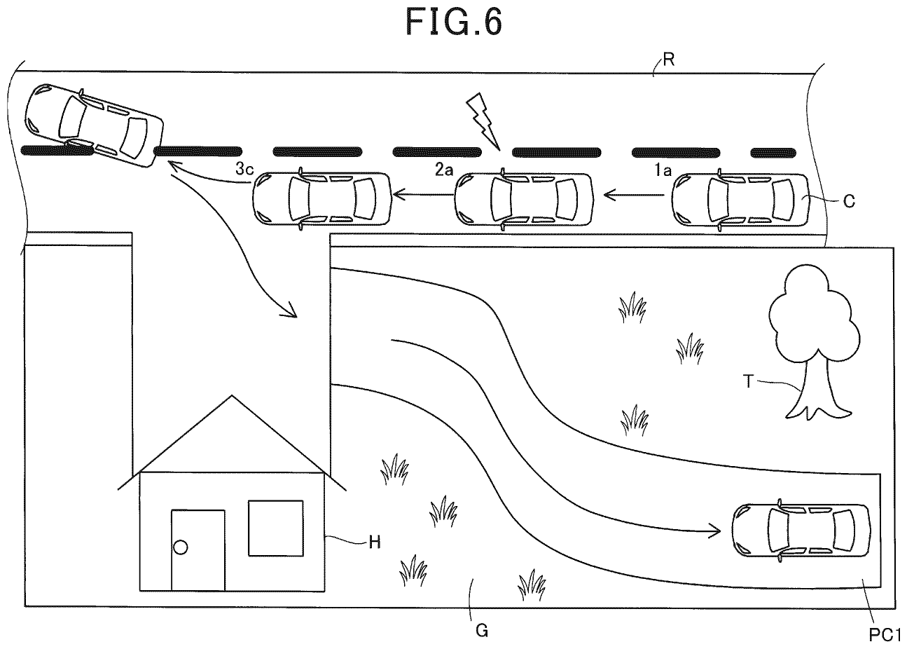

The parking route storage unit 34 stores therein a route for autonomous driving performed at the third assistance level in advance. As shown in FIG. 6, on a parking route from position 3c to a parkable area PC1 at the own home H, an area undesirable for the own vehicle C to enter, such as a yard G or an area in which a tree Tis planted in the vicinity of the own home H, is present. In this case, the parking route storage unit 34 stores therein a parking route avoiding the area undesirable for the own vehicle C to enter in advance, and the parking control unit 31 performs parking by performing vehicle speed control and steering control to follow the stored parking route at the third assistance level.

For example, the parking route stored in the parking route storage unit 34 may be a route followed during parking performed by manual operation by the passenger. Autonomous parking by the parking control unit 31 may be performed by recreating the operations of the drive apparatus 51, the braking apparatus 52, the steering apparatus 53, and the lighting apparatus 54 during the parking performed by manual operation by the passenger. The manual operation is stored in the storage unit 32 in advance. In addition, the parking route may be stored in advance by the passenger using the map information stored in the storage unit 32.

As a result of the parking assistance system 101 according to the second embodiment described above, the parking route storage unit 34 that stores therein the parking route for the parkable area PC1 in advance is further provided. The parking control unit 31 performs vehicle speed control and steering control to park the vehicle in the parkable area using the stored parking route when the assistance level determination unit 30 determines the assistance level to be the third assistance level. Therefore, compared to a configuration in which the stored parking route is not used, a more appropriate parking assistance can be performed and convenience can be enhanced.

### C. Third Embodiment

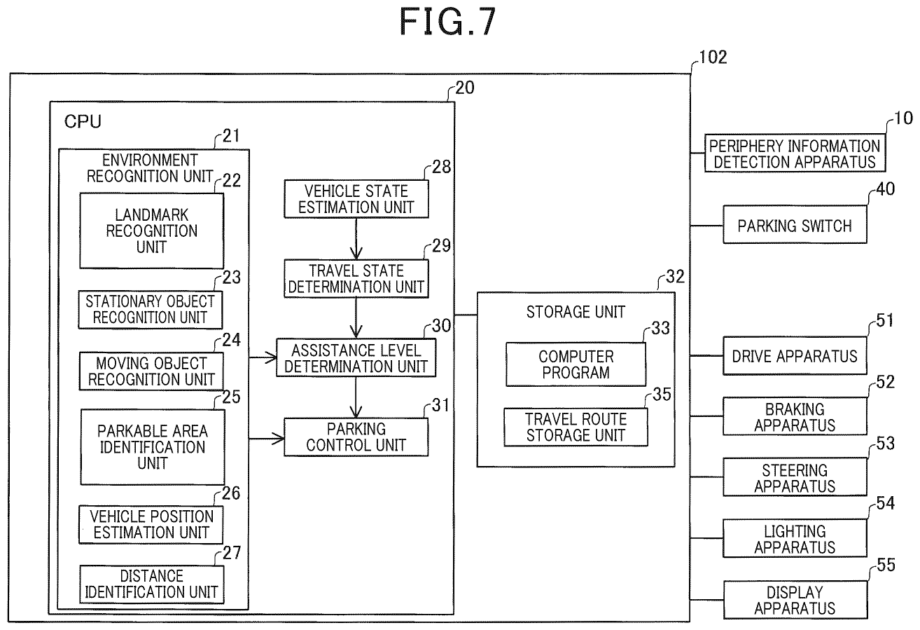

A parking assistance system 102 according to a third embodiment shown in FIG. 7 differs from the parking assistance system 100 according to the first embodiment in that a travel route storage unit 35 is further provided. Other configurations of the parking assistance system 102 according to the third embodiment are identical to those of the parking assistance system 100 according to the first embodiment. Therefore, identical constituent elements are given the same reference numbers and detailed descriptions thereof are omitted.

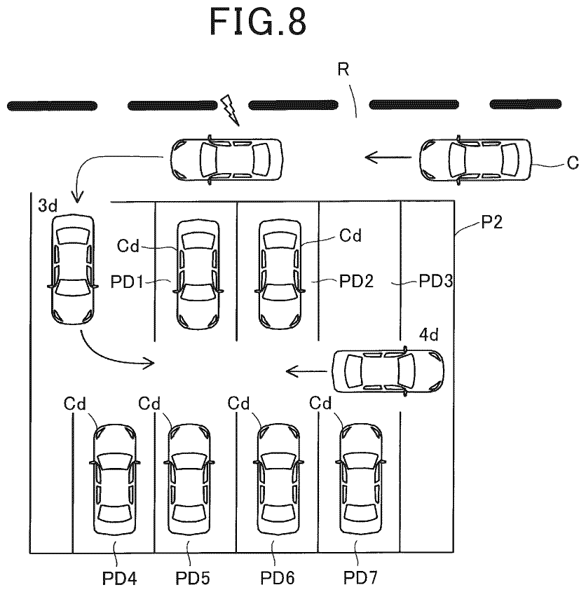

The travel route storage unit 35 stores therein a route for approaching the parkable area. More specifically, the travel route storage unit 35 stores therein a route from entry into a parking site P2 that is an area including the parkable area. As shown in FIG. 8, when the own vehicle C enters the parking site P2 and stops at position 3d, the parking control unit 31 performs parking assistance at the third assistance level. Among seven parking sections PD1, PD2, PD3, PD4, PD5, PD6, and PD7 in the parking site P2, the parking sections PD1, PD2, PD4, PD5, PD6, and PD7 other than the parking section PD3 already have other vehicles Cd parked therein. Therefore, the parking control unit 31 advances the vehicle to position 4d to perform parking in the parking section PD3. However, because there is not sufficient space to turn the own vehicle C in position 4d, parking cannot be performed. Here, the parking control unit 31 assists the own vehicle C in retreating from the parking section PD3 using the travel route stored in the travel route storage unit 35. More specifically, as a result of the passenger pressing the parking switch 40 again while the parking assistance system 102 is performing parking assistance, retreat assistance from the parking section PD3 is started. For example, when the parking switch 40 is pressed while the own vehicle C is traveling, the parking control unit 31 may perform steering control such that the own vehicle C retreats from the parking section PD3 using the travel route stored in the travel route storage unit 35 as the second assistance level. Vehicle speed control is performed by the passenger. In addition, when the parking switch 40 is pressed while the own vehicle C is stopped, the parking control unit 31 performs vehicle speed control and steering control such that the own vehicle C retreats from the parking section PD3 using the travel route stored in the travel route storage unit 35 as the third assistance level. In this manner, retreat of the own vehicle C from the parking section PD3 is assisted. Here, start of retreat assistance is not limited to the parking switch 40 and may be started by a switch other than the parking switch being pressed.

As a result of the parking assistance system 102 according to the third embodiment described above, the travel route storage unit 35 that stores therein the travel route of the own vehicle C from entry into the parking site P2 is further included. The parking control unit 31 performs steering control such that the own vehicle C retreats from the parkable area at the second assistance level and performs vehicle speed control and the steering control such that the own vehicle C retreats from the parkable area at the third assistance level. Therefore, even in cases in which the own vehicle C is unable to park in the parkable area, the own vehicle C can safely retreat from the parkable area through parking assistance from the parking assistance system 102.

### D. Other Embodiments

(D1) according to the above-described embodiments, before the parking control unit 31 performs parking control, notification to confirm execution of parking control may be performed. For example, this notification may be displayed in the display apparatus 55. As a result of the passenger pressing a confirmation button on the touch panel for the notification, the parking control unit 31 performs the parking control corresponding to the assistance level.

(D2) According to the above-described embodiments, an example in which parking assistance from the first assistance level to the third assistance level is performed in order is described. However, the present disclosure is not limited thereto. The first assistance level may be omitted and parking assistance starting from the second assistance level may be performed. Alternatively, the second assistance level may be omitted, and parking assistance at the first assistance level and the third assistance level may be continuously performed.

(D3) According to the above-described embodiments, the parking switch 40 is not limited to a physical button, and the system may be such that the parking assistance process is started by voice recognition.

(D4) According to the above-described embodiments, the parking control unit 31 may set an upper speed limit for the speed of the vehicle at the first assistance level. For example, the upper speed limit may be a relatively low speed. A speed such as this may be, for example, 20 km per hour. As a result of the upper speed limit being set, transition to parking assistance at the second assistance level in which vehicle speed control or steering control is performed can be smoothly and safely performed. More specifically, when the speed set by vehicle speed control at the second assistance level is a low speed such as 5 km per hour, speed difference during transition from the first assistance level to the second assistance level can be reduced as a result of the upper speed limit such as 20 km per hour being set at the first assistance level. In addition, when steering control is performed at the second assistance level, as a result of the upper speed limit being set, safety during transition from the first assistance level to the second assistance level can be ensured compared to a configuration in which the upper speed limit is not set.

(D5) According to the third embodiment, the travel route storage unit 35 stores therein the travel route of the own vehicle after entry into the parking site P2. However, the present disclosure is not limited thereto. The travel route storage unit 35 may store therein a recent travel route of the own vehicle. For example, the recent travel route may be a travel route taken during previous five minutes.

The present disclosure is not limited to the above-described embodiments and variation examples, and can be implemented by various configurations without departing from the spirit of the disclosure. For example, technical features according to embodiments and variation examples that correspond to technical features in each aspect described in the summary of the invention can be replaced and combined as appropriate to solve some or all of the above-described issued or to achieve some or all of the above-described effects. Furthermore, the technical features may be omitted as appropriate unless described as a requisite in the present specification. For example, the present disclosure can be implemented according to aspects such as a parking assistance method, a computer program (computer program code) for implementing this method, and a non-transitory computer-readable storage medium in which the computer program is stored.

Characteristic configurations extracted from the embodiments described above are described below.

### Configuration 1

A parking assistance system (100, 101, 102) for a vehicle, the parking assistance system including: a travel state determination unit (29) that determines a travel state of the vehicle: an environment recognition unit (21) that recognizes a surrounding environment of the vehicle; an assistance level determination unit (30) that determines an assistance level for parking the vehicle based on the travel state and the environment; and a parking control unit (31) that performs parking control based on the determined assistance level.

### Configuration 2

The parking assistance system according to configuration 1, in which: the environment recognizing unit identifies a parkable area in which the vehicle is able to park, and identifies a distance between the vehicle and the parkable area; the assistance level determining unit determines the assistance level to be a first assistance level in response to the distance being equal to or greater than a threshold prescribed in advance, determines the assistance level to be a second assistance level in response to the distance being less than the threshold and in response to the travel state determining unit determining that the vehicle is traveling as the travel state, and determines the assistance level to be a third assistance level in response to the distance being less than the threshold and in response to the travel state determining unit determining that the vehicle is stopped as the travel state; and the parking control unit performs notification to guide a passenger of the vehicle to the parkable area in response to the assistance level determining unit determining the assistance level to be the first assistance level, performs either of vehicle speed control and steering control of the vehicle in response to the assistance level determining unit determining the assistance level to be the second assistance level, and performs vehicle speed control and steering control in response to the assistance level determining unit determining the assistance level to be the third assistance level.

### Configuration 3

The parking assistance system according to configuration 2, further including: a parking route storage unit (34) that stores therein in advance a parking route to the parkable area, in which the parking control unit performs vehicle speed control and steering control to park the vehicle in the parkable area using the stored parking route in response to the assistance level determining unit determining the assistance level to be the third assistance level.

### Configuration 4

The parking assistance system according to configuration 2, further including: a travel route storage unit (35) that stores therein a travel route from entry into a parking site that is an area including the parkable area, in which the parking control unit performs steering control such that the vehicle retreats from the parkable area using the stored travel route in response to the assistance level determining unit determining the assistance level to be the second assistance level, and performs vehicle speed control and steering control such that the vehicle retreats from the parkable area using the stored travel route in response to the assistance level determining unit determining the assistance level to be the third assistance level.

### Configuration 5

A parking assistance system for a vehicle, the parking assistance system including: at least one of a circuit and a processor with a memory storing computer program code executable by the processor, the at least one of the circuit and the processor configured to cause the parking assistance system to: determine a travel state of the vehicle: recognize a surrounding environment of the vehicle; determine an assistance level for parking the vehicle based on the travel state and the environment; and perform parking control based on the determined assistance level.

### Configuration 6

The parking assistance system according to configuration 5, in which: the at least one of the circuit and the processor is further configured to cause the parking assistance system to: identify a parkable area in which the vehicle is able to park; identify a distance between the vehicle and the parkable area; determine the assistance level to be a first assistance level in response to the distance being equal to or greater than a threshold prescribed in advance; determine the assistance level to be a second assistance level in response to the distance being less than the threshold and in response to the parking assistance system determining that the vehicle is traveling as the travel state; determine the assistance level to be a third assistance level in response to the distance being less than the threshold and in response to the parking assistance system determining that the vehicle is stopped as the travel state; perform notification to guide a passenger of the vehicle to the parkable area in response to the parking assistance system determining the assistance level to be the first assistance level, perform either of vehicle speed control and steering control of the vehicle in response to the parking assistance system determining the assistance level to be the second assistance level; and perform vehicle speed control and steering control in response to the parking assistance system determining the assistance level to be the third assistance level.

### Configuration 7

The parking assistance system according to configuration 6, in which: the at least one of the circuit and the processor is further configured to cause the parking assistance system to: store therein in advance a parking route to the parkable area; and perform vehicle speed control and steering control to park the vehicle in the parkable area using the stored parking route in response to the parking assistance system determining the assistance level to be the third assistance level.

### Configuration 8

The parking assistance system according to configuration 6, in which: the at least one of the circuit and the processor is further configured to cause the parking assistance system to: store therein a travel route from entry into a parking site that is an area including the parkable area; perform steering control such that the vehicle retreats from the parkable area using the stored travel route in response to the parking assistance system determining the assistance level to be the second assistance level; and perform vehicle speed control and steering control such that the vehicle retreats from the parkable area using the stored travel route in response to the parking assistance system determining the assistance level to be the third assistance level.

### Configuration 9

A parking assistance method for a vehicle, the parking assistance method including: determining a travel state of the vehicle: recognizing a surrounding environment of the vehicle; determining an assistance level for parking the vehicle based on the travel state and the environment; and performing parking control based on the determined assistance level.

### Configuration 10

The parking assistance method according to configuration 9, in which: recognizing the surrounding environment of the vehicle includes identifying a parkable area in which the vehicle is able to park, and identifying a distance between the vehicle and the parkable area; determining the assistance level for parking the vehicle includes determining the assistance level to be a first assistance level in response to the distance being equal to or greater than a threshold prescribed in advance, determining the assistance level to be a second assistance level in response to the distance being less than the threshold and in response to the parking assistance method determining that the vehicle is traveling as the travel state, and determining the assistance level to be a third assistance level in response to the distance being less than the threshold and in response to the parking assistance method determining that the vehicle is stopped as the travel state; and performing parking control includes performing notification to guide a passenger of the vehicle to the parkable area in response to the parking assistance method determining the assistance level to be the first assistance level, performing either of vehicle speed control and steering control of the vehicle in response to the parking assistance method determining the assistance level to be the second assistance level, and performing vehicle speed control and steering control in response to the parking assistance method determining the assistance level to be the third assistance level.

### Configuration 11

The parking assistance method according to configuration 10, further including: storing therein in advance a parking route to the parkable area, in which performing parking control further includes performing vehicle speed control and steering control to park the vehicle in the parkable area using the stored parking route in response to the parking assistance method determining the assistance level to be the third assistance level.

### Configuration 12

The parking method according to configuration 10, further including: storing therein a travel route from entry into a parking site that is an area including the parkable area, in which performing parking control further includes performing steering control such that the vehicle retreats from the parkable area using the stored travel route in response to the parking assistance method determining the assistance level to be the second assistance level, and performing vehicle speed control and steering control such that the vehicle retreats from the parkable area using the stored travel route in response to the parking assistance method determining the assistance level to be the third assistance level.

What is claimed is:

1. A parking assistance system for a vehicle, the parking assistance system comprising:
a travel state determination unit that determines a travel state of the vehicle:
an environment recognition unit that recognizes a surrounding environment of the vehicle;
an assistance level determination unit that determines an assistance level for parking the vehicle based on the travel state and the environment; and
a parking control unit that performs parking control based on the determined assistance level.

2. The parking assistance system according to claim 1, wherein:
the environment recognizing unit identifies a parkable area in which the vehicle is able to park, and identifies a distance between the vehicle and the parkable area;
the assistance level determining unit
determines the assistance level to be a first assistance level in response to the distance being equal to or greater than a threshold prescribed in advance,
determines the assistance level to be a second assistance level in response to the distance being less than the threshold and in response to the travel state determining unit determining that the vehicle is traveling as the travel state, and
determines the assistance level to be a third assistance level in response to the distance being less than the threshold and in response to the travel state determining unit determining that the vehicle is stopped as the travel state; and
the parking control unit
performs notification to guide a passenger of the vehicle to the parkable area in response to the assistance level determining unit determining the assistance level to be the first assistance level,
performs either of vehicle speed control and steering control of the vehicle in response to the assistance level determining unit determining the assistance level to be the second assistance level, and
performs vehicle speed control and steering control in response to the assistance level determining unit determining the assistance level to be the third assistance level.

3. The parking assistance system according to claim 2, further comprising:
a parking route storage unit that stores therein in advance a parking route to the parkable area, wherein
the parking control unit performs vehicle speed control and steering control to park the vehicle in the parkable area using the stored parking route in response to the assistance level determining unit determining the assistance level to be the third assistance level.

4. The parking assistance system according to claim 2, further comprising:
a travel route storage unit that stores therein a travel route from entry into a parking site that is an area including the parkable area, wherein
the parking control unit
performs steering control such that the vehicle retreats from the parkable area using the stored travel route in response to the assistance level determining unit determining the assistance level to be the second assistance level, and
performs vehicle speed control and steering control such that the vehicle retreats from the parkable area using the stored travel route in response to the assistance level determining unit determining the assistance level to be the third assistance level.

5. A parking assistance system for a vehicle, the parking assistance system comprising:
at least one of a circuit and a processor with a memory storing computer program code executable by the processor, the at least one of the circuit and the processor configured to cause the parking assistance system to:
determine a travel state of the vehicle:
recognize a surrounding environment of the vehicle;
determine an assistance level for parking the vehicle based on the travel state and the environment; and
perform parking control based on the determined assistance level.

6. The parking assistance system according to claim 1, wherein:
the at least one of the circuit and the processor is further configured to cause the parking assistance system to:
identify a parkable area in which the vehicle is able to park;
identify a distance between the vehicle and the parkable area;
determine the assistance level to be a first assistance level in response to the distance being equal to or greater than a threshold prescribed in advance;
determine the assistance level to be a second assistance level in response to the distance being less than the threshold and in response to the parking assistance system determining that the vehicle is traveling as the travel state;
determine the assistance level to be a third assistance level in response to the distance being less than the threshold and in response to the parking assistance system determining that the vehicle is stopped as the travel state;
perform notification to guide a passenger of the vehicle to the parkable area in response to the parking assistance system determining the assistance level to be the first assistance level,
perform either of vehicle speed control and steering control of the vehicle in response to the parking assistance system determining the assistance level to be the second assistance level; and
perform vehicle speed control and steering control in response to the parking assistance system determining the assistance level to be the third assistance level.

7. The parking assistance system according to claim 6, wherein:
the at least one of the circuit and the processor is further configured to cause the parking assistance system to:
store therein in advance a parking route to the parkable area; and
perform vehicle speed control and steering control to park the vehicle in the parkable area using the stored parking route in response to the parking assistance system determining the assistance level to be the third assistance level.

8. The parking assistance system according to claim 6, wherein:
the at least one of the circuit and the processor is further configured to cause the parking assistance system to:
store therein a travel route from entry into a parking site that is an area including the parkable area;
perform steering control such that the vehicle retreats from the parkable area using the stored travel route in response to the parking assistance system determining the assistance level to be the second assistance level; and
perform vehicle speed control and steering control such that the vehicle retreats from the parkable area using the stored travel route in response to the parking assistance system determining the assistance level to be the third assistance level.

9. A parking method for a vehicle, the parking assistance method comprising:
determining a travel state of the vehicle:
recognizing a surrounding environment of the vehicle;
determining an assistance level for parking the vehicle based on the travel state and the environment; and
performing parking control based on the determined assistance level.

10. The parking assistance method according to claim 9, wherein:
recognizing the surrounding environment of the vehicle comprises
identifying a parkable area in which the vehicle is able to park, and
identifying a distance between the vehicle and the parkable area;
determining the assistance level for parking the vehicle comprises
determining the assistance level to be a first assistance level in response to the distance being equal to or greater than a threshold prescribed in advance,
determining the assistance level to be a second assistance level in response to the distance being less than the threshold and in response to the parking assistance method determining that the vehicle is traveling as the travel state, and
determining the assistance level to be a third assistance level in response to the distance being less than the threshold and in response to the parking assistance method determining that the vehicle is stopped as the travel state; and
performing parking control comprises
performing notification to guide a passenger of the vehicle to the parkable area in response to the parking assistance method determining the assistance level to be the first assistance level,
performing either of vehicle speed control and steering control of the vehicle in response to the parking assistance method determining the assistance level to be the second assistance level, and
performing vehicle speed control and steering control in response to the parking assistance method determining the assistance level to be the third assistance level.

11. The parking assistance method according to claim 10, further comprising:
storing therein in advance a parking route to the parkable area, wherein
performing parking control further comprises
performing vehicle speed control and steering control to park the vehicle in the parkable area using the stored parking route in response to the parking assistance method determining the assistance level to be the third assistance level.

12. The parking assistance method according to claim 10, further comprising:
storing therein a travel route from entry into a parking site that is an area including the parkable area, wherein
performing parking control further comprises
performing steering control such that the vehicle retreats from the parkable area using the stored travel route in response to the parking assistance method determining the assistance level to be the second assistance level, and
performing vehicle speed control and steering control such that the vehicle retreats from the parkable area using the stored travel route in response to the parking assistance method determining the assistance level to be the third assistance level.
